(19) United States
(12) Patent Application Publication
(10) Pub. No.: US 2005/0045478 A1
(43) Pub. Date: Mar. 3, 2005

(54) Manufacturing method for an electrophoretic display

(75) Inventors: Chi-Chang Liao, Hsinchu (TW); Kang-Hung Liu, Hsinchu (TW); Lung-Pin Hsin, Hsinchu (TW); Yi-Chun Wong, Hsinchu (TW); Yi-An Sha, Hsinchu (TW); Ching-Hsiang Chan, Hsinchu (TW); Chia-Rong Sheu, Hsinchu (TW); Chung-Wen Wu, Hsinchu (TW); Yao-Sheng Lin, Hsinchu (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 10/673,270

(22) Filed: Sep. 30, 2003

(30) Foreign Application Priority Data
Aug. 28, 2003 (TW) 092123824

(51) Int. Cl. B05D 5/12; B05D 5/06; G01L 1/20

(52) U.S. Cl. 204/471; 427/58; 204/496

(57) ABSTRACT

a manufacturing method for an electrophoretic display applying optical polymer material is provided. The main characteristic is that the charged pigment particles are confined with optical polymer material so as to achieve electrophoretic display. In the manufacturing process, a first layer of optical polymer material is coated on an auxiliary substrate having a buffer layer for performing an optical polymerization manufacturing process. After the polymerization, on the first layer of the optical polymer material layer, the manufacturing process required by the electrophoretic display is further performed. After a second layer of optical polymer material is coated on a substrate required by the electrophoretic display having a plurality of electrode patterns, by using a mask exposure, the optical polymer material is solidified to form a polymer wall, or a molding method is applied with ultraviolet irradiation for solidifying the optical polymer material so as to form the polymer wall. Next, in a hole formed by the polymer wall, the mixture formed by the charged pigment particles and a few amount of optical polymer material is filled, and the auxiliary substrate is aligned with the substrate so as to perform the mask exposure polymerization manufacturing process. Therefore, the auxiliary substrate is combined with the substrate. Finally, the auxiliary substrate is stripped out so as to finish the manufacturing of a single substrate electrophoretic display.

### BACKGROUND OF THE INVENTION

1. Field of the Invention

The present invention relates to a manufacturing method for an electrophoretic display to reduce the thickness and weight of the display, and particularly, to a manufacturing method applied to a flexible plastic substrate. In addition, the method has fewer steps for manufacturing process, and the conditions for the manufacturing process are more easily controlled. Furthermore, the display has various modes.

2. Description of the Prior Art

As the personal digital electricity products are more and more popular, the portable display panels are developed from the seven segment digit display in the early days to colorful multi-media display panels nowadays. Obviously, it is more and more important to apply the displays in the personal digital communication products. The displays to be applied in the portable digital products must have the following requirement: to be colorful, to be capable of saving electricity, and to be light and thin. In the future, the displays also have to be flexible. In order to achieve the requirements of being light, thin and flexible, the plastic single substrate display has the characteristics to meet the above requirements. The Philips incorporation provides an application of using a phase separated composite organic film (PSCOF) method to make the liquid crystal molecules confined between an optical polymer and a plastic substrate so as to form a flexible single substrate liquid crystal display. Another prior art worth of notice is the electrophoretic display technology provided by the E Ink incorporation. The technology is related to the microencapsulation electrophoretic display technology. In the technology, the pigment particles are capsulized so as to be pasted on the substrate in a membranized way, and the pigment charged particles are moved by varying electricity field for displaying. To the electrophoretic display, this is a very different from the radiating method of the liquid crystal display. For example, the electrophoretic display mainly applies the charged pigment particles for displaying by using an optical scattering pigment method. This is different from the method used in the liquid crystal display using the ion rotation (or twist) to change the optical phase. As to the view angle for the display, the electrophoretic display is also better than the liquid crystal display.

The technology disclosed in the patent WO 02/42832 A2 applied to the world intellectual property organization (WIPO), assigned to the Philips incorporation, relates to a thin film manufacturing method for a liquid crystal display. This is related to a manufacturing process technology for a novel plastic substrate display, and also to a technology for a flexible liquid crystal display. In the description for the technology, the optical polymer material is used for confining the liquid crystal on the substrate. The main step for the manufacturing process is shown in FIGS. 1A to 1E. First, in FIG. 1A, a layer of optical polymer material mixture 2 is coated on a substrate 1. This optical polymer material mixture 2 is composed of NOA65 and a liquid crystal material. In a FIG. 1B, a scraper 3 is used for flatting the optical polymer material mixture 2. In FIG. 1C, an optical mask is positioned on the optical polymer material mixture 2. Then, ultraviolet rays 5 are used for performing an exposure process. The portions of the optical polymer material mixture 2 irradiated by the ultraviolet rays 5 are solidified and polymerized to form a plurality of polymer wall pillars 20 as shown in FIG. 1D. In FIG. 1E, a second exposure manufacturing process is used to perform a long time exposure by applying weaker ultraviolet rays 6. This will make the surface of the optical polymer material mixture 2 polymerized so as to form a thin solidification layer 21 and accomplish the process for separating the liquid crystal and the optical polymer material.

In the patent assigned to the Philips incorporation, the manufacturing process method requires twice exposures so as to form a polymer structure confined with liquid crystals. When performing the second exposure, the low energy and long time manufacturing process is required. This may make the liquid crystal material inferior. In addition, the window for the manufacturing process is small and the yield is low, and the applicable display modes are fewer. Besides, because the conditions for the manufacturing process and the display characteristics of the liquid crystal display are not easily controlled. Therefore, the present invention provides an improved manufacturing method for an electrophoretic display. The electrophoretic display not only has the characteristics of enhanced compactness, low electricity consumption, wide view angle and flexibility, but also can be easily controlled. Therefore, the object to simplify the manufacturing process, to promote the yield, and to increase the display modes can be achieved.

### SUMMARY OF THE INVENTION

The present invention relates to a manufacturing method for an electrophoretic display. First, a first layer of optical polymer material confining charged pigment particles is coated on an auxiliary substrate having a buffer layer so as to perform an optical polymerization manufacturing process. Then, the polymerized first layer of optical polymer material is further performed with the manufacturing process required by the electrophoretic display. A second layer of optical polymer material is coated on the substrate having a plurality of pixel electrodes and manufacturing process required by the electrophoretic display has be performed, and then by using a mask to perform exposure or by using a molding method applied with ultraviolet irradiation, the optical polymer material is solidified to form a polymer wall. Next, in a hole formed by the polymer wall, the mixture formed by the charged pigment particles and a few amount of optical polymer material is filled. Then, the auxiliary substrate is aligned with the substrate so as to perform the mask exposure polymerization manufacturing process for combining the auxiliary substrate and the substrate. Finally, the auxiliary substrate is stripped out so as to accomplish the manufacturing of a single substrate electrophoretic display.

Furthermore, by using the method for the present invention, an electrophoretic display without substrate can be formed. The present invention also can practice a method having intervals.

### BRIEF DESCRIPTION OF THE DRAWINGS

The accompanying drawings, which are incorporated in and form part of the specification in which like numerals designate like parts, illustrate preferred embodiments of the present invention and together with the description, serve to explain the principles of the invention. In the drawings:

FIG. 1A to 1E are the perspective diagrams of a manufacturing process for a prior art single substrate liquid crystal display;

FIG. 2A to 2M are the perspective diagrams of a manufacturing process for a single substrate electrophoretic display according to a first embodiment of the present invention;

FIG. 3A to 3M are the perspective diagrams of a manufacturing process for a single substrate electrophoretic display according to a second embodiment of the present invention;

FIG. 4A to 4L are the perspective diagrams of a manufacturing process for a single substrate electrophoretic display according to a third embodiment of the present invention;

FIG. 5A to 5L are the perspective diagrams of a manufacturing process for a single substrate electrophoretic display according to a fourth embodiment of the present invention;

FIG. 6A to 6M are the perspective diagrams of a manufacturing process for an electrophoretic display without substrate according to a fifth embodiment of the present invention; and

FIG. 7A to 7M are the perspective diagrams of a manufacturing process for an electrophoretic display without substrate according to a sixth embodiment of the present invention.

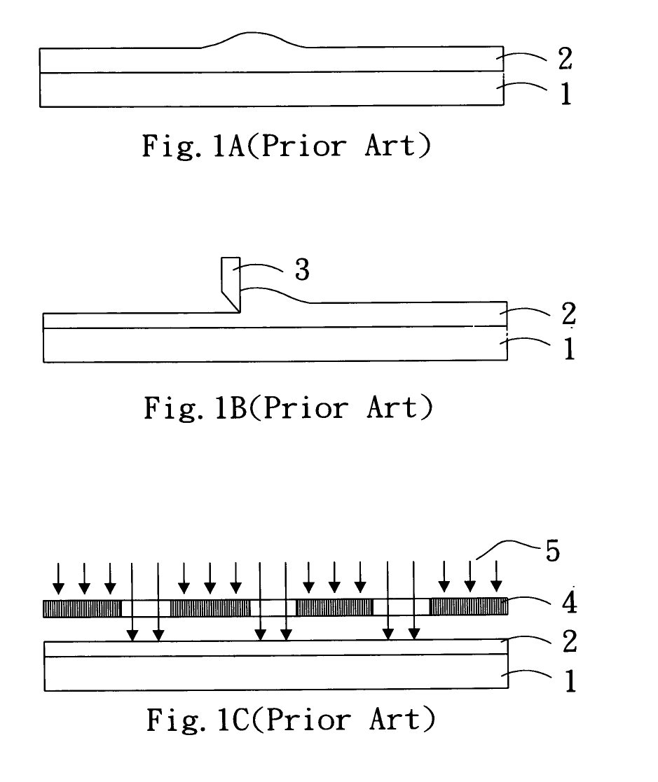

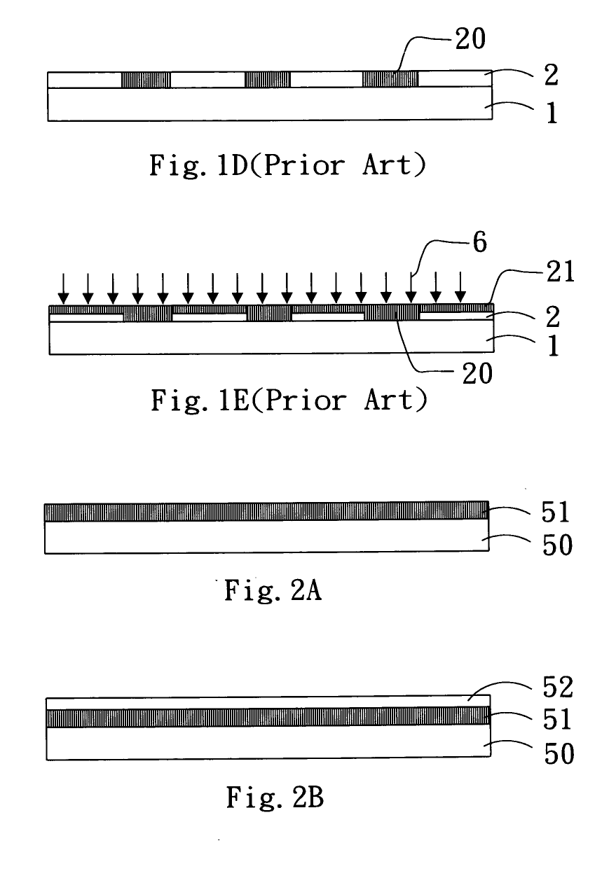

### DETAILED DESCRIPTION OF THE PREFERRED EMBODIMENT

The present invention relates to a manufacturing method for an electrophoretic display. This display has the advantages of good flexibility, wide view angle and low electricity consumption. By using the separation method, the pigment particles are confined, and the exposure developing or molding method is used for manufacturing the polymer walls. Finally, a substrate/lower and upper substrates is/are stripped so as to accomplish the manufacturing of a single substrate electrophoretic display/an electrophoretic display without substrate.

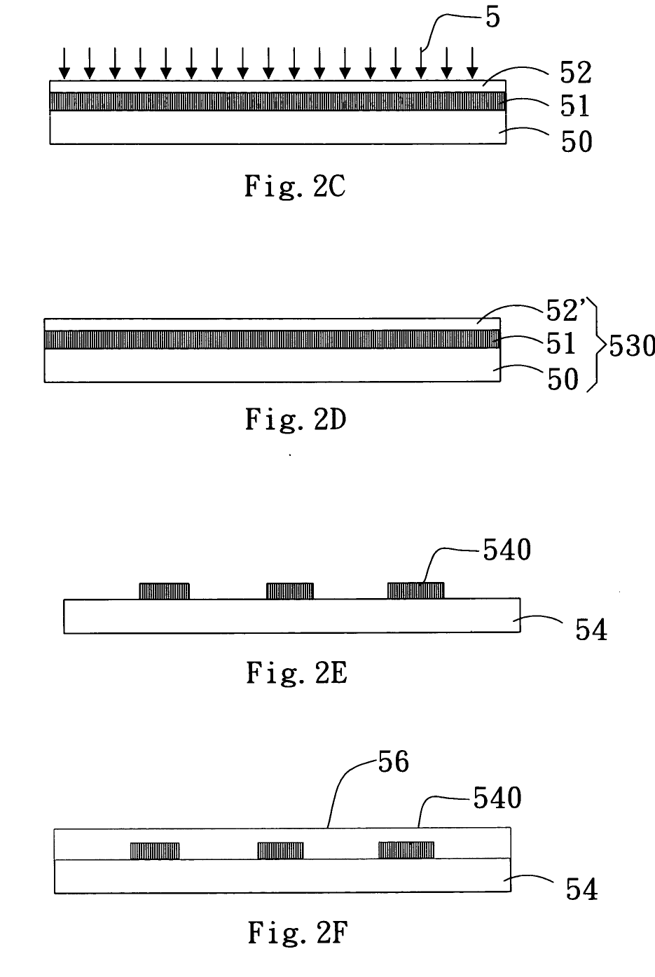

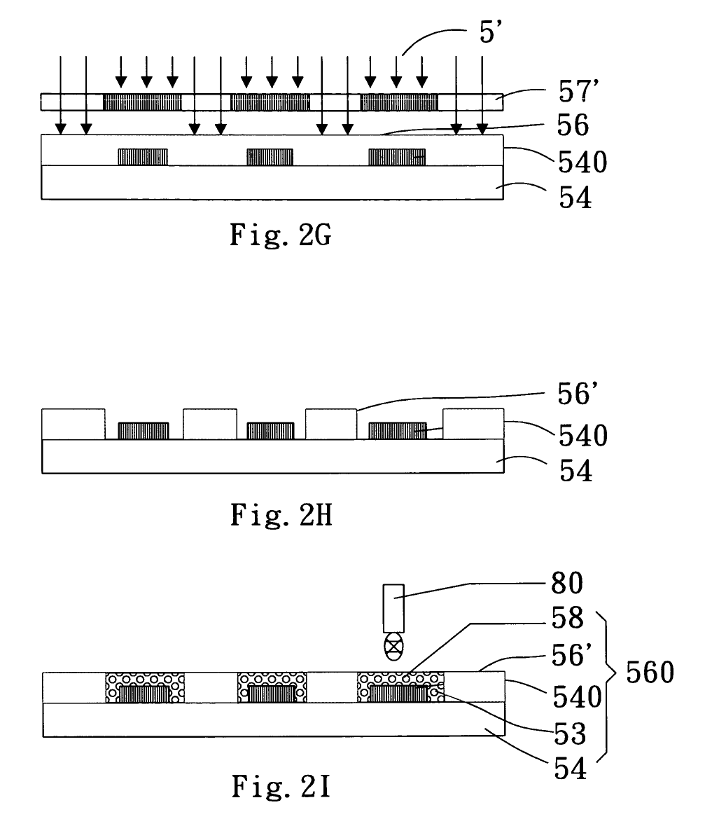

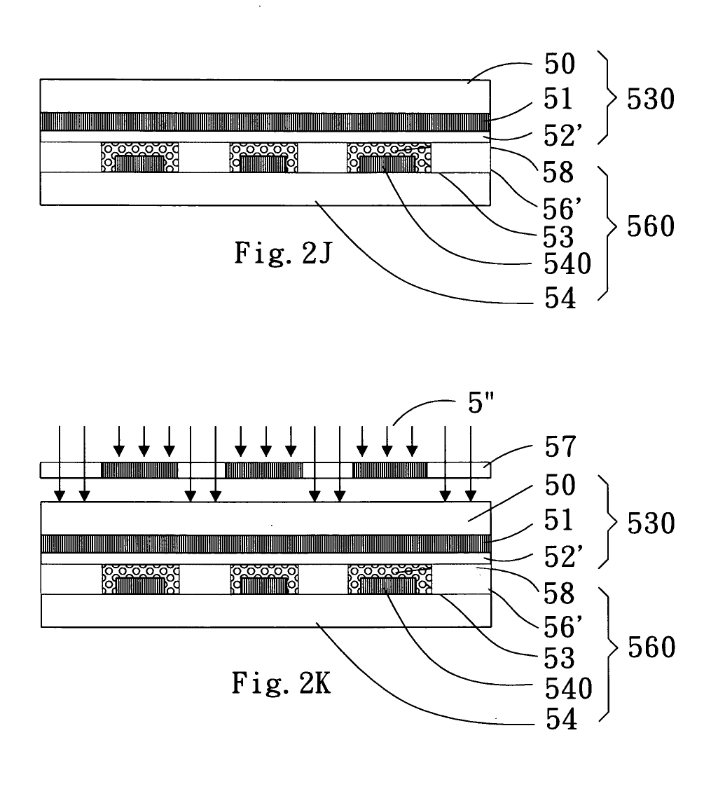

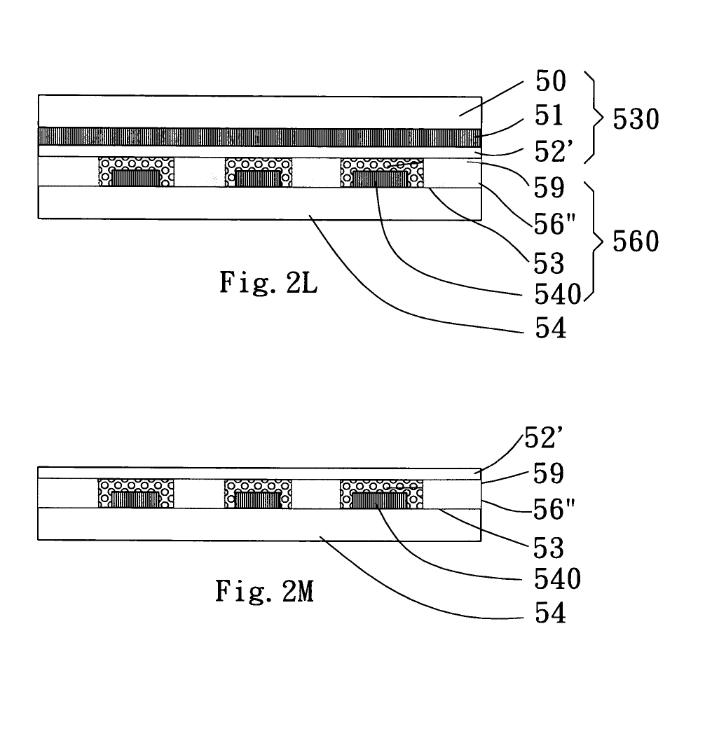

First, please refer to FIG. 2A to 2M. FIG. 2A to 2M are the perspective diagrams of a manufacturing process for a single substrate electrophoretic display according to a first embodiment of the present invention. The process comprises the following steps.

Please refer to FIG. 2A to 2D. FIG. 2A to 2D are the perspective diagrams of a manufacturing process for a first board. In FIG. 2A, a buffer layer 51 is manufactured on an auxiliary substrate 50. In FIG. 2B, an optical polymer material layer 52 (such as NOA65/NOA72 optical polymer material) is coated on the buffer layer 51. In FIG. 2C, ultraviolet rays 5 are irradiated for performing the exposure manufacturing process. In FIG. 2D, ultraviolet rays 5 are used for solidifying the optical polymer material 52 so as to form polymer 52′. The above is the manufacturing process for making the first board 530.

FIG. 2E to 2I are the perspective diagrams of a manufacturing process for a second board. In FIG. 2E, electrode patterns 540 are manufactured on a substrate 54. In FIG. 2F, an optical polymer material 56 is coated on the substrate 54 and the electrode patterns 540. In FIG. 2G, an optical mask 57′ is used for performing exposure manufacturing process for the ultraviolet rays 5′. In FIG. 2H, after the optical polymer material 56 is performed with the optical mask exposure manufacturing process, the optical polymer material 56 is solidified and polymerized so as to form a plurality of polymer walls 56′. In FIG. 2I, in holes surrounded by the polymer walls 56′, an injection device 80 is used for injecting mixture 58 composed of a few amount of optical polymer material and charged pigment particles. The mixture 58 is the mixing solution mixed with pigment particles and monomers. The above steps are performed for accomplishing the manufacturing of the second board 560.

FIG. 2J to 2M are the perspective diagrams of a process for combining the first board 530 and the second board 560. First, in FIG. 2J, the first board 530 is reversely positioned on the second board 560. In FIG. 2K, on the first board 530, the exposure manufacturing process for the ultraviolet rays 5″ is performed. After the exposure manufacturing process, by the separation of the mixture 58 composed of charged pigment particles and a few amount of optical polymer material, the first board 530 is combined with the second board 560. In FIG. 2L, the combination of the first board 530 and the second board 560 is accomplished, and the charged pigment particles are separated from the optical polymer material. Therefore, the charged pigment particle solution 59 is fully confined by the polymer. In FIG. 2M, the auxiliary substrate 50 and the buffer layer 51 of the first board 530 are stripped so as to accomplish the manufacturing of the single substrate electrophoretic display.

It should be noticed that the present invention is related to the manufacturing method for an electrophoretic display. The manufactured electrophoretic display applies the electrophoretic modes for displaying. This is very different from the liquid crystal display, and the manufacturing method is very different from that of the liquid crystal display.

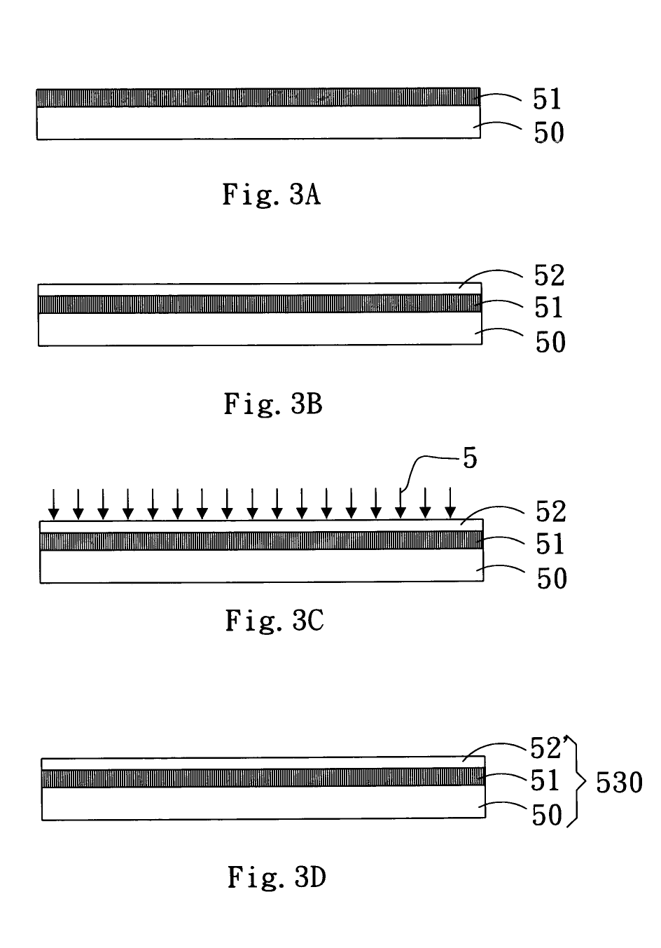

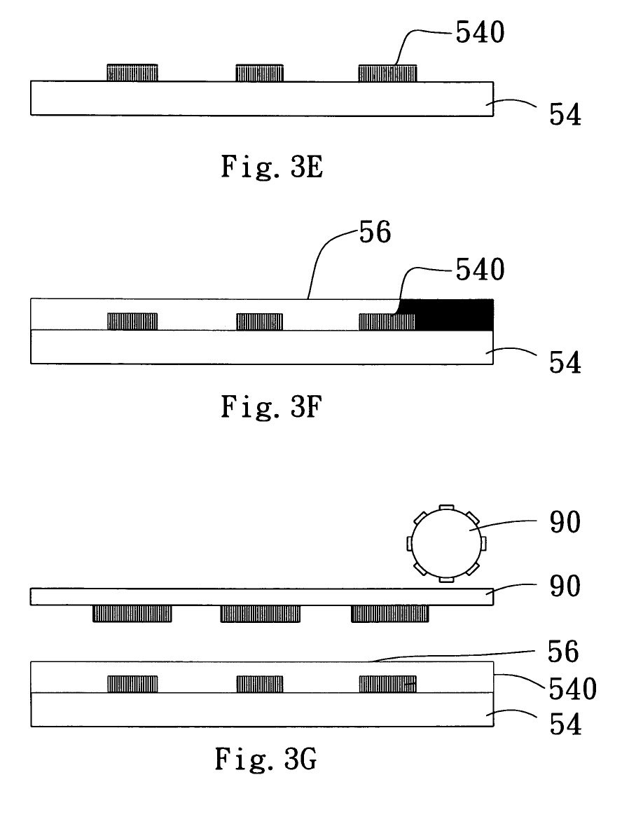

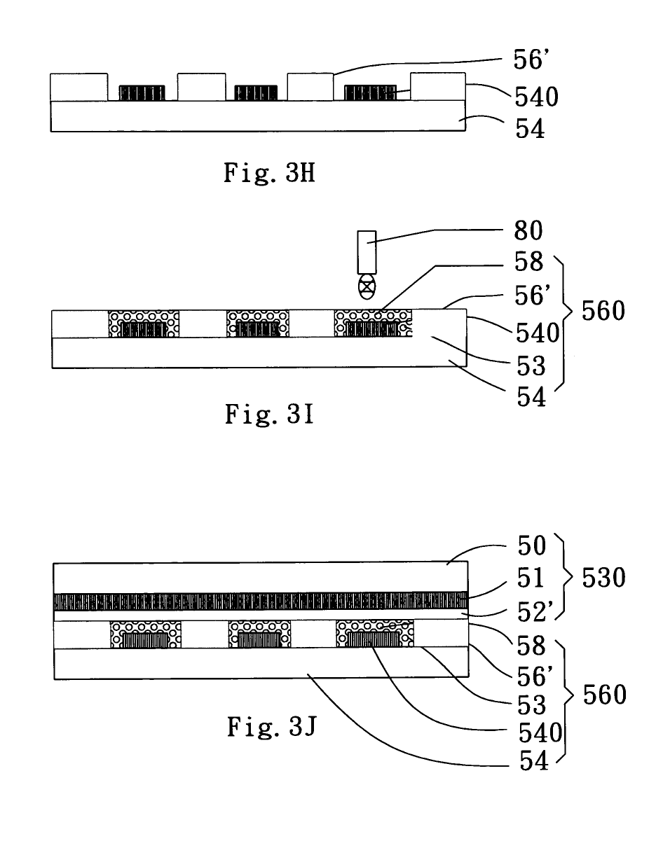

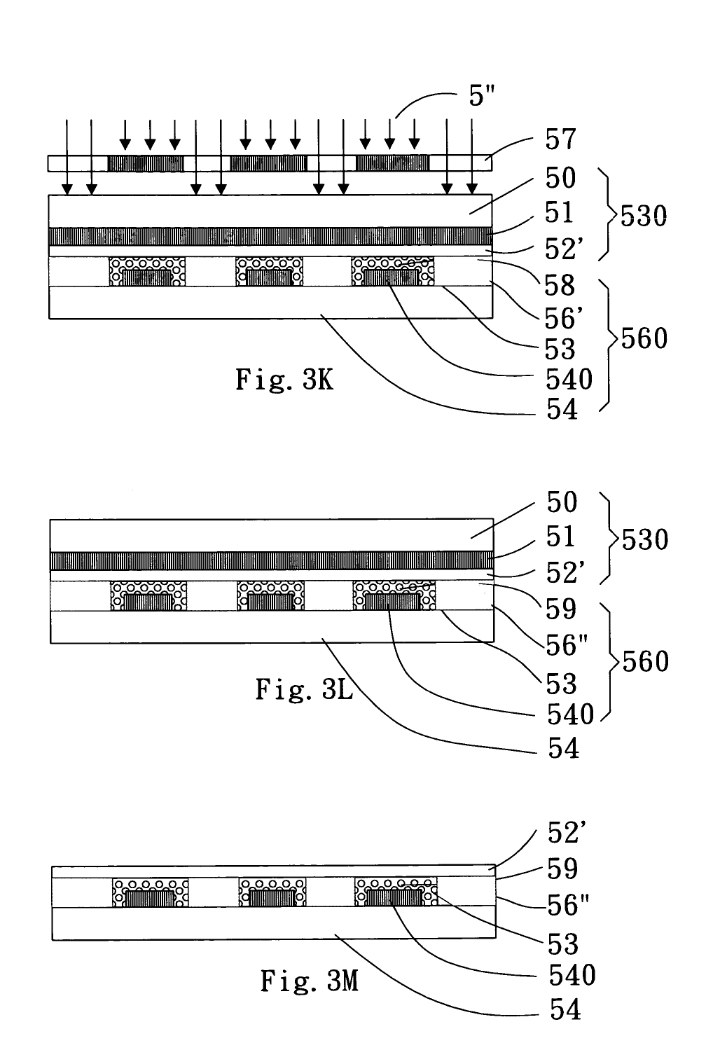

FIG. 3A to 3M are the perspective diagrams of a manufacturing process for a single substrate electrophoretic display according to a second embodiment of the present invention. This manufacturing process is similar with that for the first embodiment. The main difference is the second embodiment applies the molding method for manufacturing the polymer walls. The following are the steps for this manufacturing process.

FIG. 3A to FIG. 3D are the perspective diagrams of a manufacturing process for a first board 530. In FIG. 3A, one buffer layer 51 is manufactured on an auxiliary substrate 50. In FIG. 3B, an optical polymer material layer 52 (such as NOA65/NOA72 optical polymer material) is coated on the buffer layer 51. In FIG. 3C, by irradiating ultraviolet rays 5, an exposure manufacturing process is performed. In FIG. 3D, the ultraviolet rays 5 are used for solidifying the optical polymer material 52 so as to form the polymer 52′. Therefore, the manufacturing process for the first board 530 is accomplished.

FIG. 3E to 3I are the perspective diagrams of a manufacturing process for a second board. In FIG. 3E, electrode patterns 540 are manufactured on a substrate 54. In FIG. 3F, an optical polymer material 56 is coated on the substrate 54 and the electrode patterns 540. In FIG. 3G, a molding device 90 is used for performing the molding manufacturing process to cooperate with the irradiation of the ultraviolet rays. In FIG. 3H, after the optical polymer material 56 is performed with the molding process and the irradiation of the ultraviolet rays, it is solidified to form polymer walls 56′ (polymer matrix). In FIG. 3I, in holes surrounded by the polymer walls 56′, an injection device 80 is used for injecting mixture 58 composed of charged pigment particles and a few amount of optical polymer material. The mixture 58 is the mixing solution mixed with pigment particles and monomers. The above steps are performed for accomplishing the manufacturing of the second board 560.

FIG. 3J to 3M are the perspective diagrams of a process for combining the first board 530 and the second board 560. First, in FIG. 3J, the first board 530 is reversely positioned on the second board 560. In FIG. 3K, on the first board 530, an optical mask 57 is used for performing the exposure manufacturing process of the ultraviolet rays 5″, after the exposure manufacturing process of the ultraviolet rays 5″, by the separation of the mixture 58 composed of charged pigment particles and a few amount of optical polymer material, the first board 530 is combined with the second board 560. In FIG. 3L, the combination of the first board 530 and the second board 560 is accomplished, and the charged pigment particles are separated from the optical polymer material. Therefore, the charged pigment particle solution 59 is fully confined by the polymer. In FIG. 3M, the auxiliary substrate 50 and the buffer layer 51of the first board 530 are stripped so as to accomplish the manufacturing of the single substrate electrophoretic display.

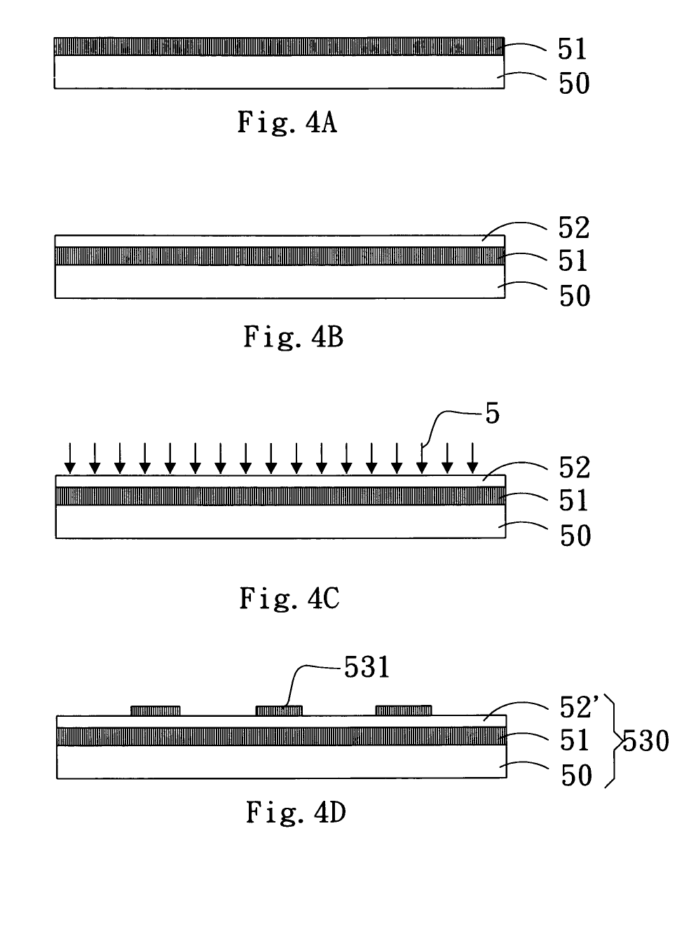

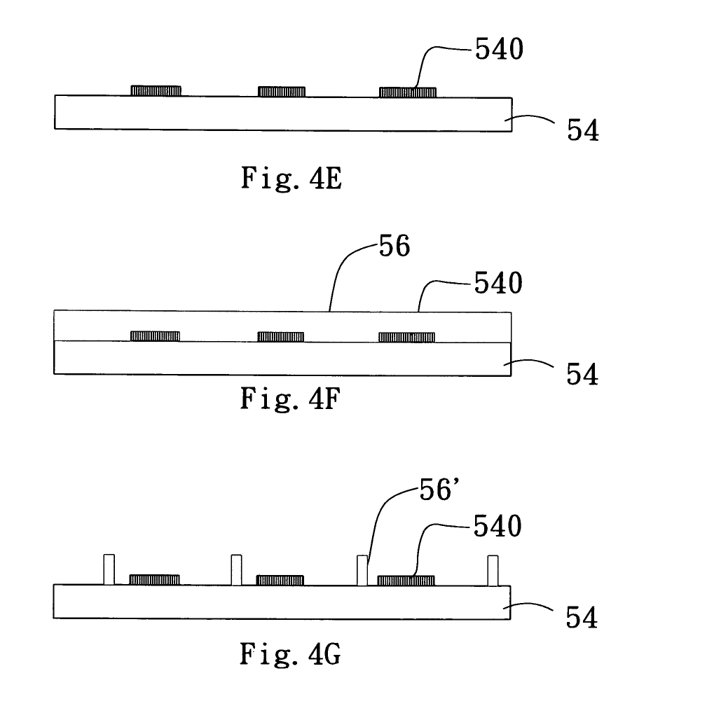

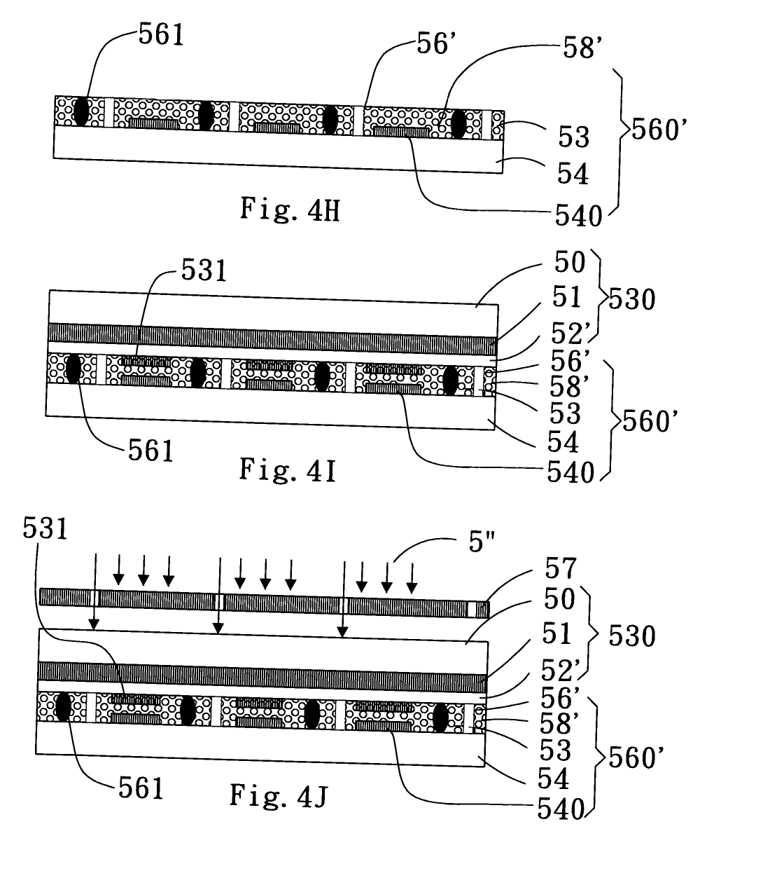

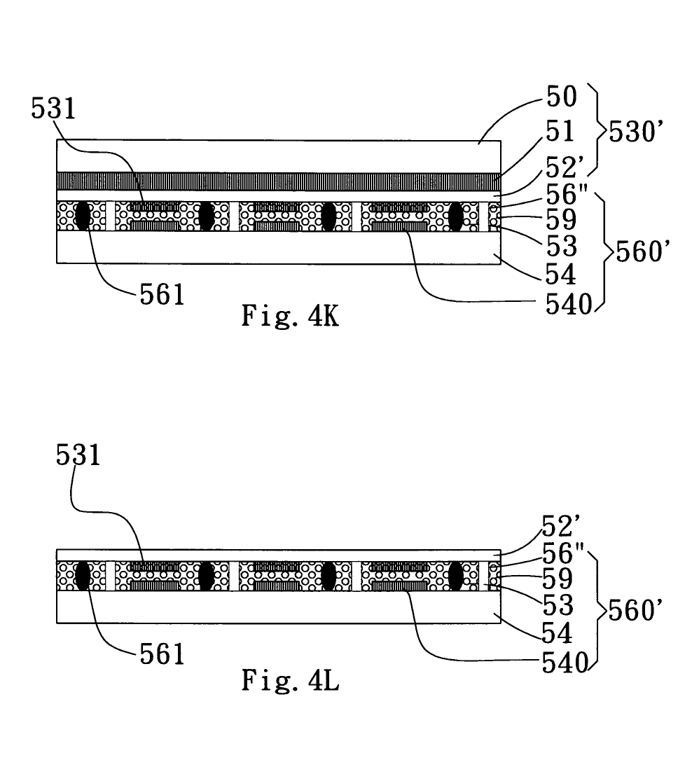

FIG. 4A to 4L are the perspective diagrams of a manufacturing process for a single substrate electrophoretic display according to a third embodiment of the present invention. This manufacturing process is similar with that of the first embodiment. The main difference is electrodes being on the first board, and the optical polymer material mixture being composed of the optical polymer material, the charged pigment particles and intervals. The manufacturing process comprises the following steps.

FIG. 4A to FIG. 4D are the perspective diagrams of a manufacturing process for a first board 530′. In FIG. 4A, one buffer layer 51 is manufactured on an auxiliary substrate 50. In FIG. 4B, an optical polymer material layer 52 (such as NOA65/NOA72 optical polymer material) is coated on the buffer layer 51. In FIG. 4C, the exposure manufacturing process is performed to irradiate the ultraviolet rays 5 so that the optical polymer material 52 is solidified to form polymer 52′. In FIG. 4D, electrodes 531 are manufactured on the polymer layer 52″ so as to accomplish the manufacturing of the first board 530′.

FIG. 4E to 4H are the perspective diagrams of a manufacturing process for a second board 560′. In FIG. 4E, electrode patterns 540 are manufactured on a substrate 54. In FIG. 4F, an optical polymer material 56 is coated on the substrate 54 and the electrode patterns 540. In FIG. 4G, after the optical mask exposure manufacturing process or the molding method is performed, the optical polymer material 56 is solidified to form the polymer walls 56′. In FIG. 4H, in the holes surrounded by the polymer walls 56′, the mixture 58′ composed of charged pigment particles 53, intervals 561 and a few amount of optical polymer material is filled. By performing the above steps, the manufacturing of the second board 560′ is accomplished.

FIG. 4I to 4L are the perspective diagrams of a process for combining the first board 530′ and the second board 560′. First, in FIG. 4I, the first board 530′ is reversely positioned on the second board 560′. In FIG. 4J, on the first board 530′, the exposure manufacturing process of the ultraviolet rays 5″ is performed. After the exposure manufacturing process of the ultraviolet rays 5″, the mixture 58′ composed of the charged pigment particles 53, the intervals 561 and a few amount of optical polymer material are separated so as to combine the first board 530′ and the second board 560′. In FIG. 4K, the first board 530′ is combined with the second board 560′, and the charged pigment particles are separated from the optical polymer material. Therefore, the charged pigment particle solution 59 is fully confined by the polymer. In FIG. 4L, the auxiliary substrate 50 and the buffer layer 51 of the first board 530′ are stripped so as to accomplish the manufacturing process for the single substrate electrophoretic display with two-sided electrodes where the intervals are used for controlling the thickness of the display layer.

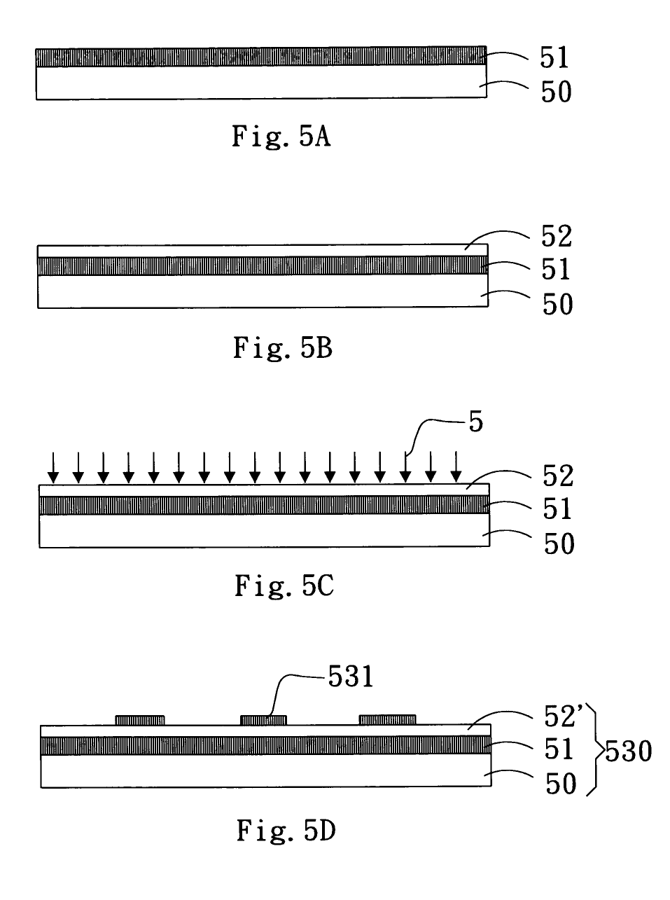

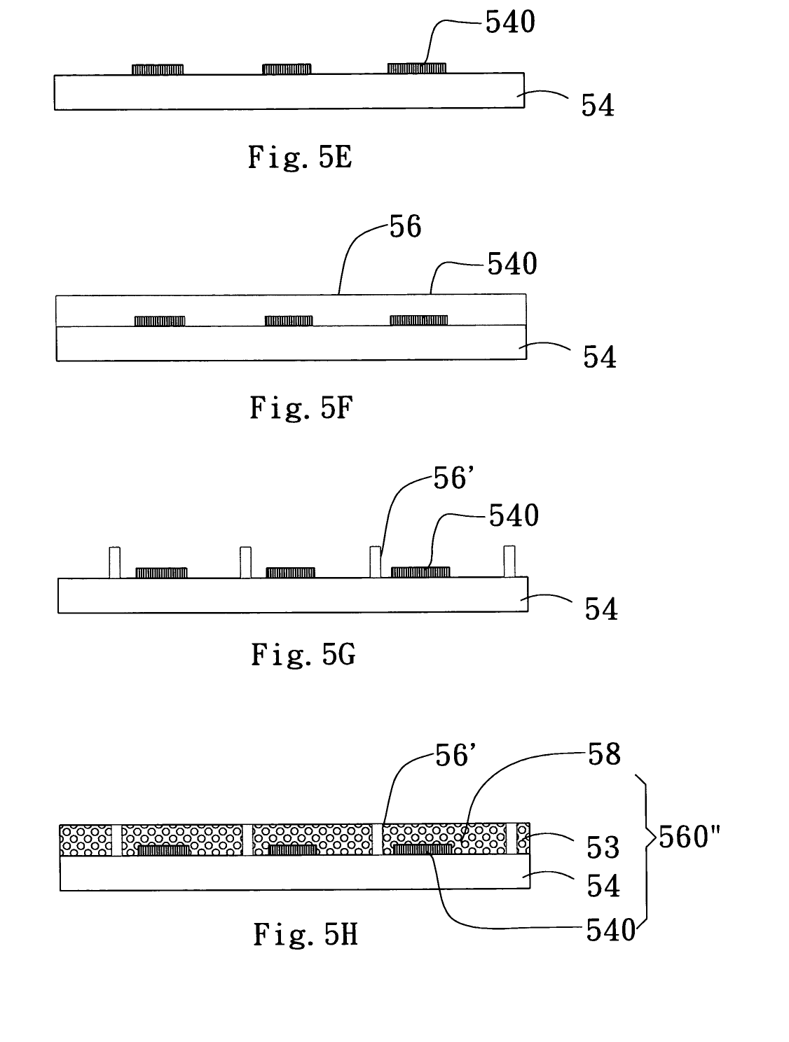

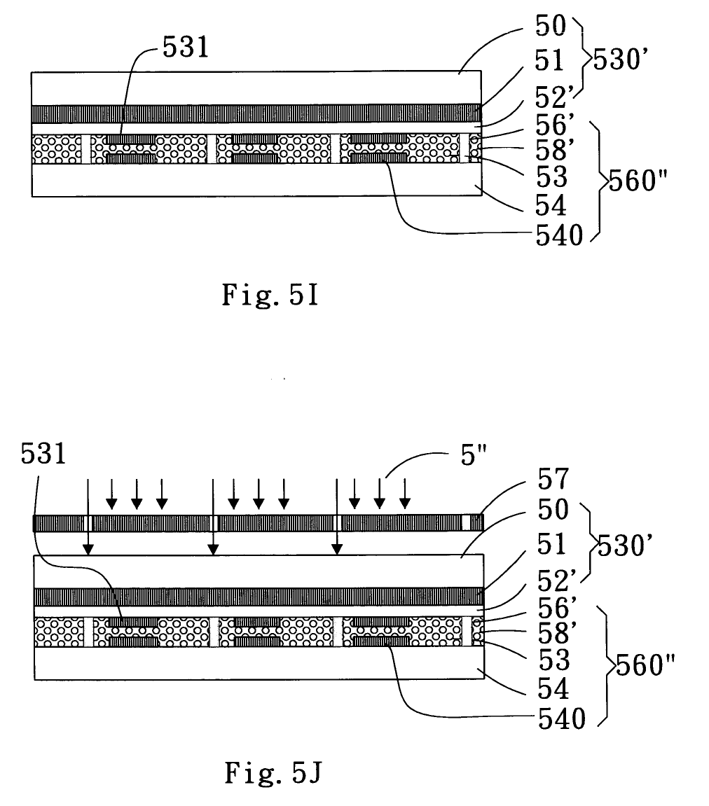

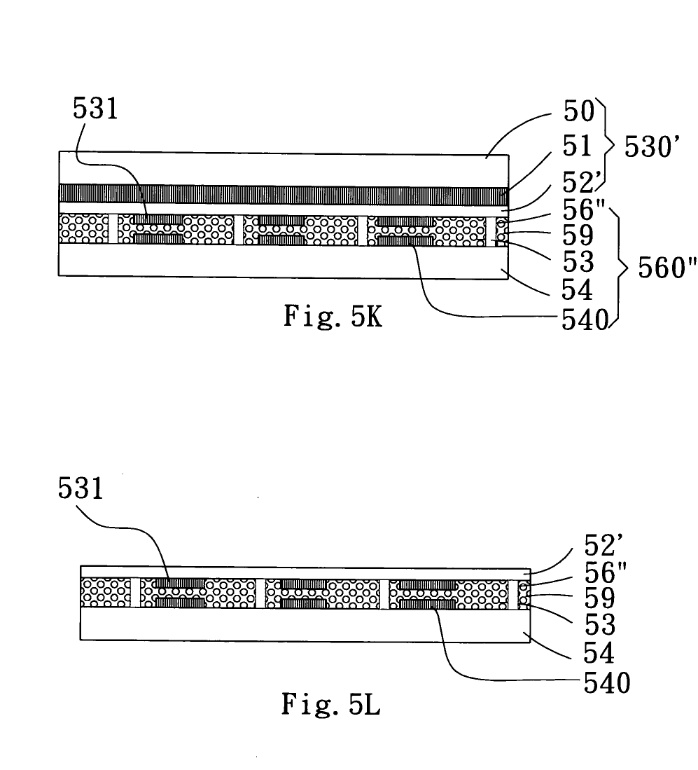

FIG. 5A to 5L are the perspective diagrams of a manufacturing process for a single substrate electrophoretic display according to a fourth embodiment of the present invention. This manufacturing process is similar to that of the third embodiment. The main difference is electrodes being on the first board, and the optical polymer material mixture being composed of the optical polymer material and the charged pigment particles, not including the intervals.

FIG. 5A to FIG. 5D are the perspective diagrams of a manufacturing process for a first board 530′. In FIG. 5A, one buffer layer 51 is manufactured on an auxiliary substrate 50. In FIG. 5B, an optical polymer material layer 52 (such as NOA65/NOA72 optical polymer material) is coated on the buffer layer 51. In FIG. 5C, the exposure manufacturing process is performed to irradiate the ultraviolet rays 5 so that the optical polymer material 52 is solidified to form polymer 52′. In FIG. 5D, electrodes 531 are manufactured on the polymer layer 52′ so as to accomplish the manufacturing of the first board 530′.

FIG. 5E to 5H are the perspective diagrams of a manufacturing process for a second board 560″. In FIG. 5E, electrode patterns 540 are manufactured on a substrate 54. In FIG. 5F, an optical polymer material 56 is coated on the substrate 54 and the electrode patterns 540. In FIG. 5G, after the optical mask exposure manufacturing process or the molding method is performed, the optical polymer material 56 is solidified and polymerized form the polymer walls 56′. In FIG. 5H, in the holes surrounded by the polymer walls 56′, the mixture 58 composed of charged pigment particles 53 and a few amount of optical polymer material is filled. By performing the above steps, the manufacturing of the second board 560″ is accomplished.

FIG. 5I to 5L are the perspective diagrams of a process for combining the first board 530′ and the second board 560″. First, in FIG. 5I, the first board 530′ is reversely positioned on the second board 560″. In FIG. 5J, on the first board 530′, the exposure manufacturing process of the ultraviolet rays 5″ is performed. After the exposure manufacturing process of the ultraviolet rays 5″, the mixture 58 composed of the charged pigment particles 53 and a few amount of optical polymer material is separated so as to combine the first board 530′ and the second board 560″. In FIG. 5K, the first board 530′ is combined with the second board 560″, and the charged pigment particles are separated from the optical polymer material. Therefore, the charged pigment particle solution 59 is fully confined by the polymer. In FIG. 5L, the auxiliary substrate 50 and the buffer layer 51of the first board 530′ are stripped so as to accomplish the manufacturing process for the single substrate electrophoretic display with two-sided electrodes.

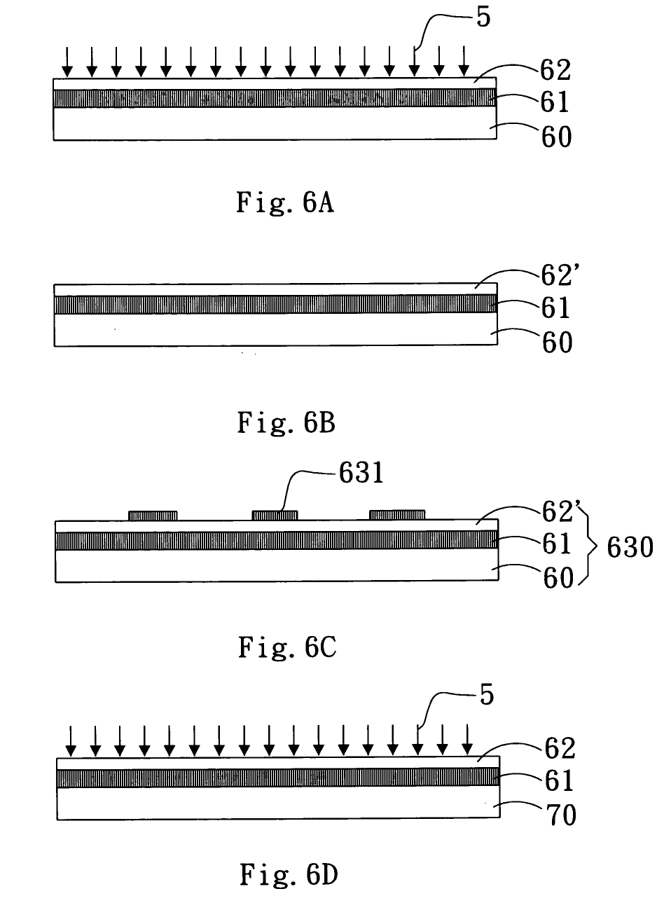

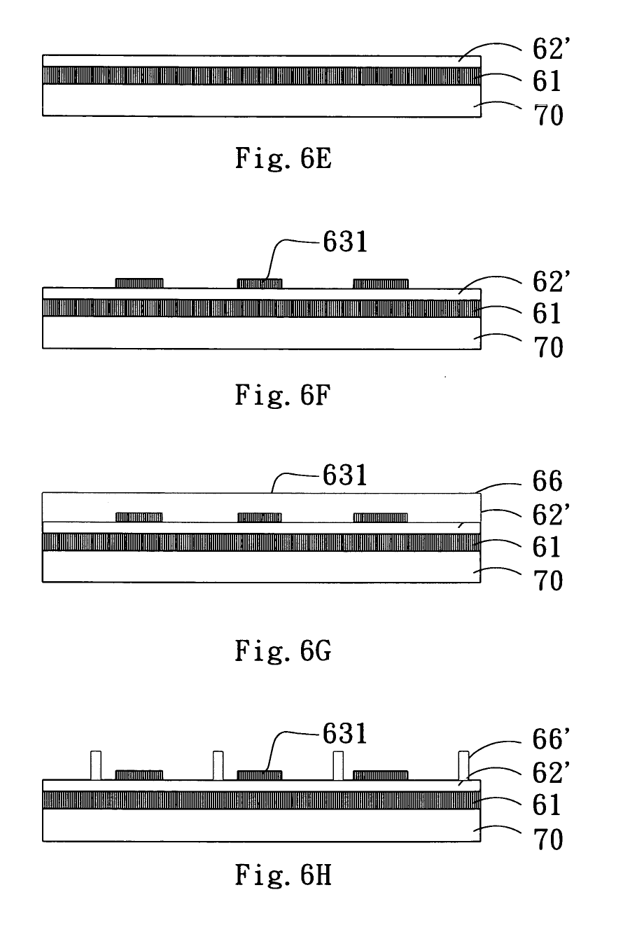

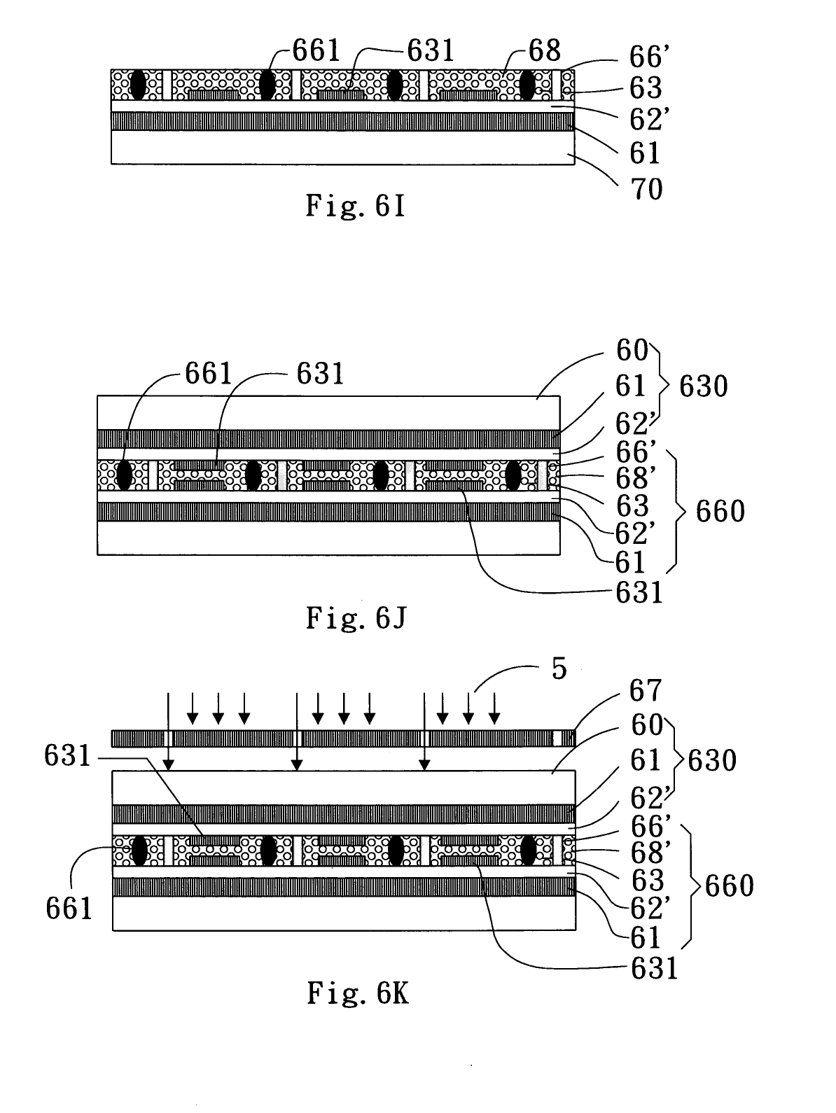

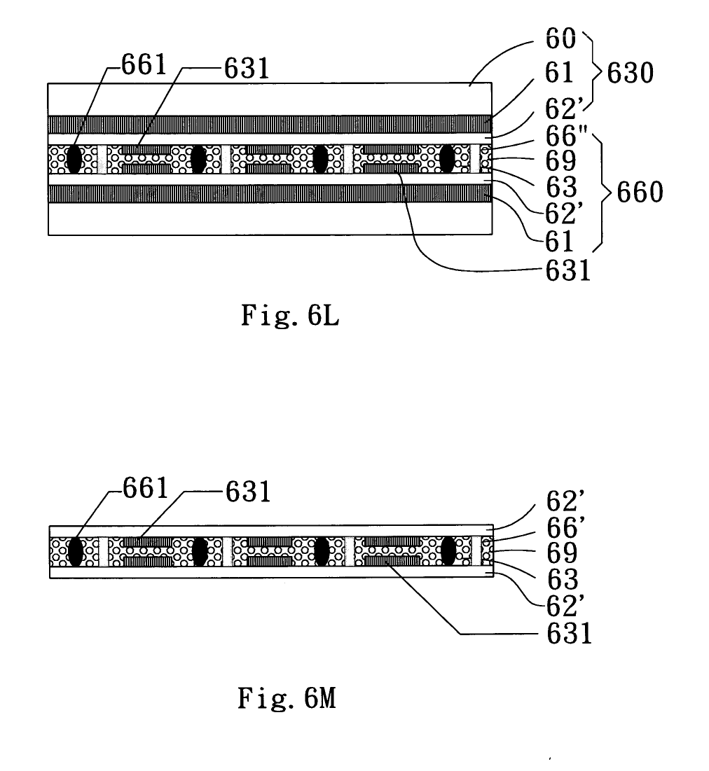

FIG. 6A to 6M are the perspective diagrams of a manufacturing process for an electrophoretic display without substrate according to a fifth embodiment of the present invention. This fifth embodiment is related to the manufacturing process for an electrophoretic display without substrate. This is very different from the electrophoretic display disclosed in the first to the fourth embodiments. First, in FIG. 6A, a buffer layer 61 is manufactured on a first auxiliary substrate 60, and an optical polymer material 62 is coated on the buffer layer 61. By irradiating the ultraviolet rays 5, the exposure process is performed. In FIG. 6B, after irradiating the ultraviolet rays 5 on the optical polymer material above the first auxiliary substrate 60, the optical polymer material 62 is solidified to form the polymer 62′. In FIG. 6C, electrodes 631 are manufactured on the surface of the polymer layer 62′ above the first auxiliary substrate 60. Therefore, the manufacturing of the first board 630 is accomplished.

In FIG. 6D, a buffer layer 61 is manufactured on a second auxiliary substrate 70, and an optical polymer material 62 is coated on the buffer layer 61. Then, by irradiating the ultraviolet rays 5, the exposure process is performed. In FIG. 6E, after the optical polymer material on the second auxiliary substrate 70 is irradiated by the ultraviolet rays 5, the optical polymer material 62 is solidified to form polymer 62′. In FIG. 6F, electrodes 631 are manufactured on the surface of the polymer layer 62′ above the second auxiliary substrate 70. In FIG. 6G, an optical polymer material 66 is coated on the surfaces of the polymer layer 62′ and the electrodes 631 of the second auxiliary substrate 70. In FIG. 6H, after the optical polymer material 66 above the second auxiliary substrate 70 is processed with the optical mask exposure manufacturing process or the molding method, the optical polymer material 66 is solidified to form the polymer walls 66′. In FIG. 6I, in the holes surrounded by the polymer walls 66′ above the second auxiliary substrate 70, the mixture 68′ composed of charged pigment particles 63, the intervals 661 and a few amount of optical polymer material is filled. By performing the above steps, the manufacturing of the second board 660 is accomplished.

In FIG. 6J, the first board 630 is reversely positioned on the second board 660. After they are aligned with each other, the exposure process is performed. In FIG. 6K, the exposure manufacturing process of the ultraviolet rays 5 is performed. After the exposure manufacturing process of the ultraviolet rays 5, the mixture 68′ composed of the charged pigment articles 63, the intervals 661 and a few amount of optical polymer material is separated so as to combine the first board 630 with the second board 660. In FIG. 6L, the first board 630 is combined with the second board 660, and the charged pigment particles 63 are separated from the optical polymer material. Therefore, the charged pigment particle solution 69 is fully confined by the polymer. In FIG. 6M, the auxiliary substrate 60 and the buffer layer 61 of the first board 630 are stripped, and the auxiliary substrate 70 and the buffer layer 61 of the second board 660 are also stripped. Therefore, the manufacturing of the electrophoretic display without substrate is accomplished. This display has two-sided electrodes, and the intervals are used for controlling the thickness of the display layer. In the fifth embodiment of the present invention, no substrate is positioned, and the liquid crystal device can be flexibly pasted and positioned on an object. For example, the liquid crystal display without substrate can be pasted on clothing, newspaper, windscreen, wall, book or file wrapper so as to form a freely pasted liquid crystal display.

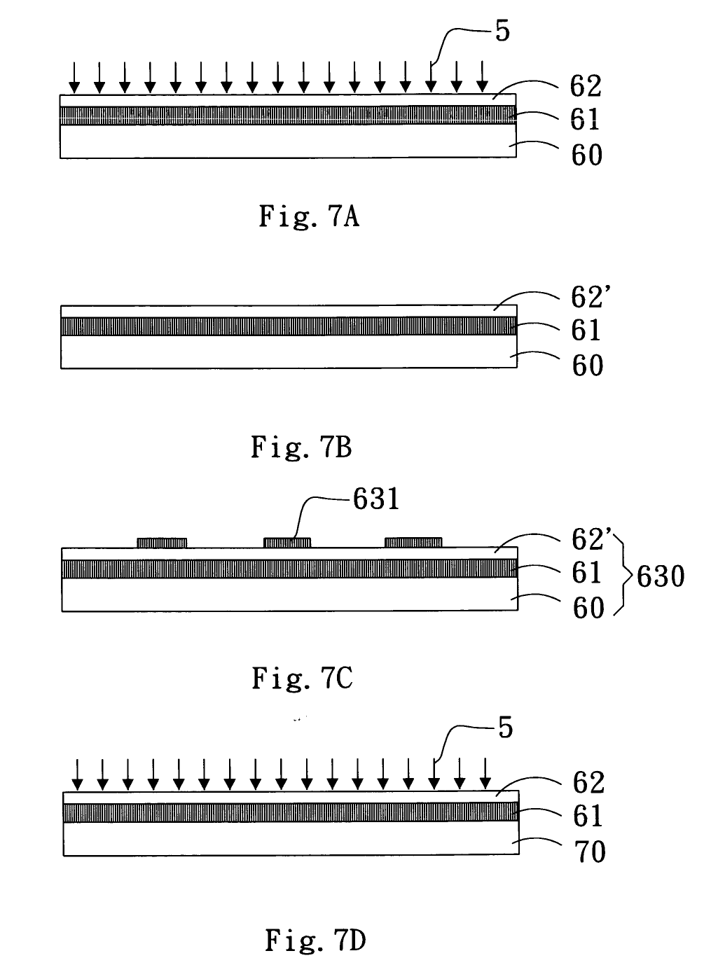

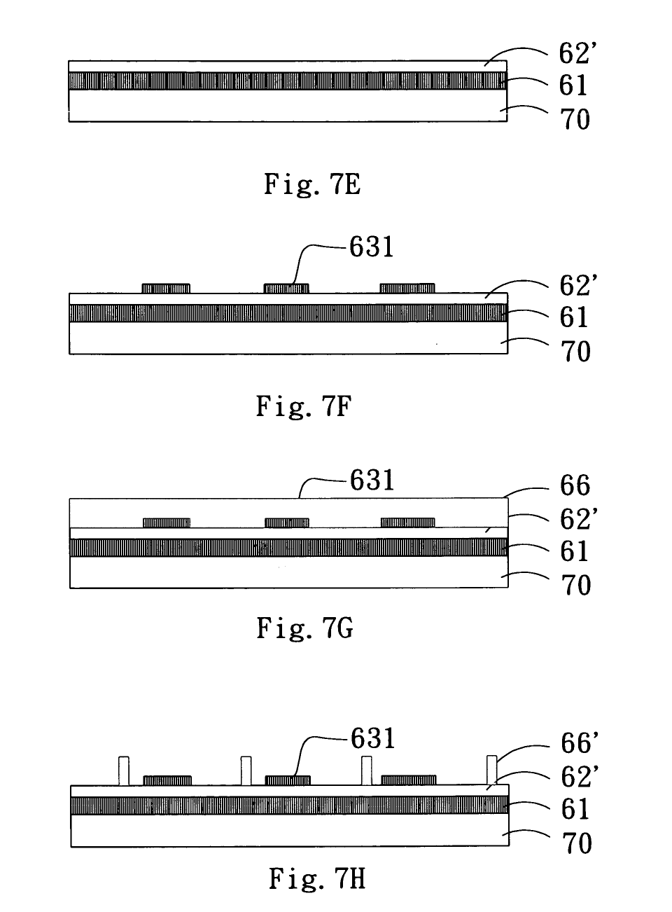

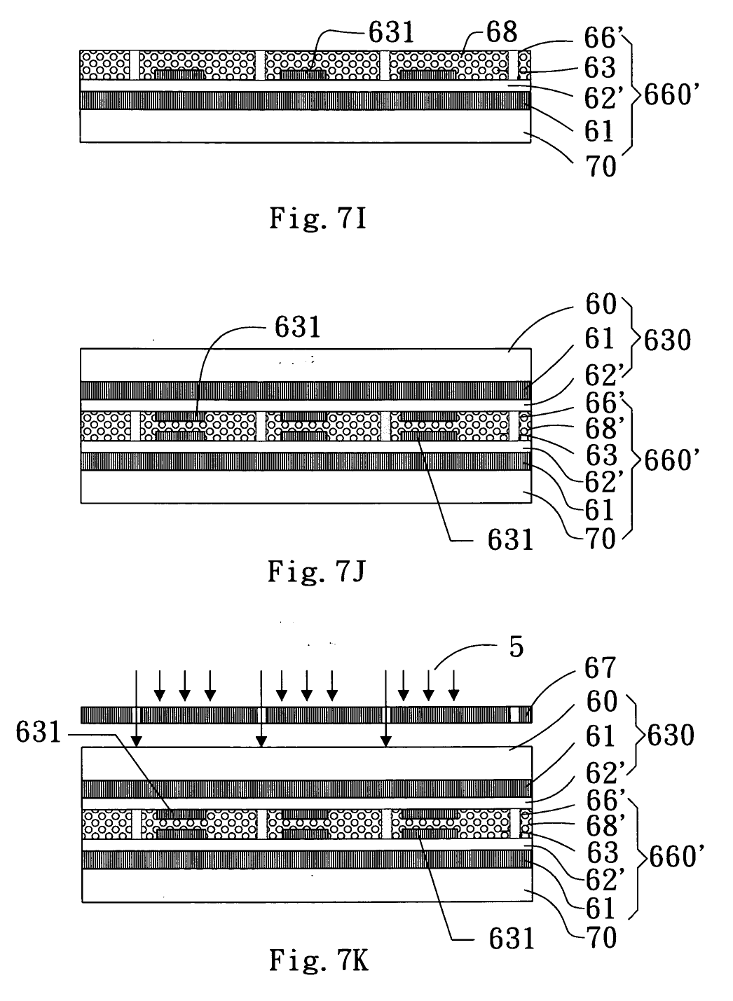

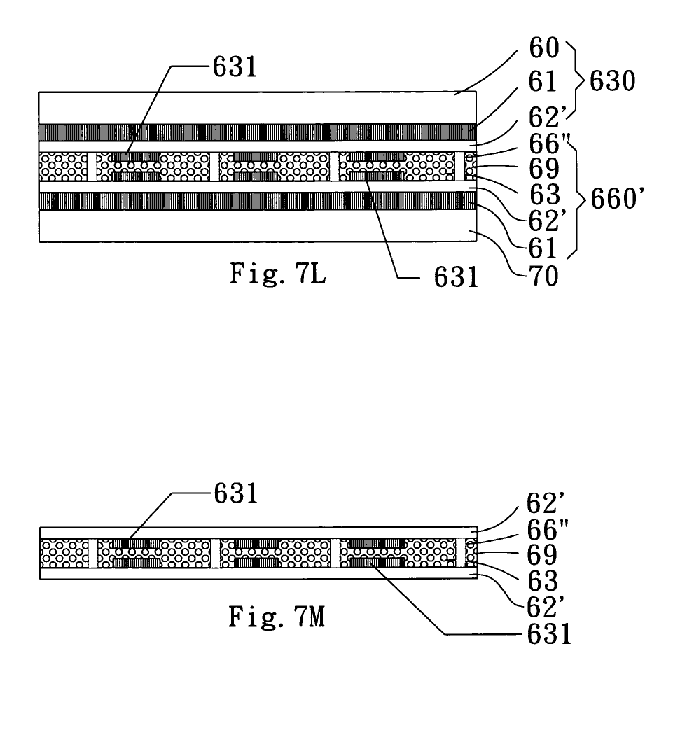

FIG. 7A to 7M are the perspective diagrams of a manufacturing process for an electrophoretic display without substrate according to a sixth embodiment of the present invention. This manufacturing process is similar to the fifth embodiment. The main difference is the optical polymer material mixture is composed of optical polymer material and the charged pigment particles, not including the intervals.

First, in FIG. 7A, a buffer layer 61 is manufactured on a first auxiliary substrate 60, and an optical polymer material 62 is coated on the buffer layer 61. By irradiating the ultraviolet rays 5, the exposure process is performed. In FIG. 7B, after irradiating the ultraviolet rays 5 on the optical polymer material above the first auxiliary substrate 60, the optical polymer material 62 is solidified to form the polymer 62′. In FIG. 7C, electrodes 631 are manufactured on the surface of the polymer layer 62′ above the first auxiliary substrate 60. Therefore, the manufacturing of the first board 630 is accomplished.

In FIG. 7D, a buffer layer 61 is manufactured on a second auxiliary substrate 70, and an optical polymer material 62 is coated on the buffer layer 61. Then, by irradiating the ultraviolet rays 5, the exposure process is performed. In FIG. 7E, after the optical polymer material on the second auxiliary substrate 70 is irradiated by the ultraviolet rays 5, the optical polymer material 62 is solidified to form polymer 62′. In FIG. 7F, electrodes 631 are manufactured on the surface of the polymer layer 62′ above the second auxiliary substrate 70. In FIG. 7G, an optical polymer material 66 is coated on the surfaces of the polymer layer 62′ and the electrodes 631 of the second auxiliary substrate 70. In FIG. 7H, after the optical polymer material 66 above the second auxiliary substrate 70 is processed with the optical mask exposure manufacturing process or the molding method, the optical polymer material 66 is solidified to form the polymer walls 66′. In FIG. 7I, in the holes surrounded by the polymer walls 66′ above the second auxiliary substrate 70, the mixture 68 composed of charged pigment particles 63 and a few amount of optical polymer material is filled. By performing the above steps, the manufacturing of the second board 660′ is accomplished.

In FIG. 7J, the first board 630 is reversely positioned on the second board 660′. After they are aligned with each other, the exposure process is performed. In FIG. 7K, the exposure manufacturing process of the ultraviolet rays 5 are performed. In FIG. 7L, after the exposure manufacturing process of the ultraviolet rays 5, the mixture 68 composed of the charged pigment articles 63 and a few amount of optical polymer material are separated so as to combine the first board 630 with the second board 660′, and the charged pigment particles 63 are separated from the optical polymer material. Therefore, the charged pigment particle solution 69 is fully confined by the polymer. In FIG. 7M, the auxiliary substrate 60 and the buffer layer 61 of the first board 630 are stripped, and the auxiliary substrate 70 and the buffer layer 61 of the second board 660′ are also stripped. Therefore, the manufacturing of the electrophoretic display without substrate is accomplished, and this display has two-sided electrodes.

In the sixth embodiment of the present invention, the display has no intervals and has no substrates. Similarly, due to omission of substrates, the electrophoretic display can be flexibly pasted and positioned on an object. For example, the electrophoretic display without substrate can be pasted on clothing, newspaper, windscreen, wall, book or file wrapper so as to form a freely pasted electrophoretic display.

In the first to sixth embodiments, the optical polymer material can be photocurable resin. In the electrophoretic display of the present invention, the optical polymer material mixture is composed of optical polymer material and charged pigment particle solution. This is very different from the liquid crystal material. Furthermore, polymer walls formed by the optical polymer material can be closed matrix polymer walls or non-closed matrix polymer walls.

In addition, in the second to the sixth embodiments, the molding method for forming the polymer walls can be cooperated with heating process or irradiation of ultraviolet rays so as to solidify and polymerize the optical polymer material to form the polymer. Besides, the auxiliary substrate of the first board or the substrate of the second board can be a substrate made of material of glass, chip, Teflon or plastics.

Furthermore, for the displaying of the electrophoretic display, a step for manufacturing a light absorption or a light reflection layer can be further performed on the auxiliary substrate or the substrate of the first to the sixth embodiments. The electrode patterns on the first board or second board are made of the material of electric conduction film. This electric conduction film is made of the material of indium-tin oxide (ITO) or polyethylene-dioxithiophene (PEDOT). The buffer layers of the first and second boards are made of the material of polyethylene hydrophobic material (PE/PEWax), long chain fatty acids, silicone, Teflon and so on.

In the embodiments of the electrophoretic display according to the present invention, the applicable material for the charged pigment particles is TiO₂. The main display mode is that of the reflective electrophoretic display. The operation mode includes coplanar electrode operation (in plane switching) and non-coplanar electrode operation. In all of the above embodiments, the manufacturing process can be the continuous roll-to-roll manufacturing process for accomplishing the manufacturing of the electrophoretic display. The number of the electrodes in the pixel area can be odd or even.

The above is the detailed description of the manufacturing method for the electrophoretic display according to the present invention. By applying the above manufacturing process, the manufacturing process method for the prior art signal substrate liquid crystal display proposed by the Philips can be improved. The present invention is mainly applied in the manufacturing of the electrophoretic display so as to promote the yield rate and increase the display modes. Furthermore, the charged pigment particles can be easily confined, and the thickness of the display layer can be effectively controlled to be more uniform.

Those skilled in the art will readily observe that numerous modifications and alterations of the device may be made while retaining the teachings of the invention. Accordingly, the above disclosure should be construed as limited only by the metes and bounds of the appended claims.

1. A manufacturing method for an electrophoretic display comprising:
performing a manufacturing process for a first board to coat an optical polymer material on an auxiliary substrate having a buffer layer and solidify the material by exposing ultraviolet rays;
performing a manufacturing process for a second board, after the optical polymer material being coated on the substrate having electrode patterns, an optical mask exposure being used for solidifying the polymerization material so as to form polymer walls, in holes surrounded by the polymer walls, a mixture composed of charged pigment particles and a few amount of optical polymer material being filled so as to accomplish the manufacturing of the second board;
performing the manufacturing process for combining the first board and the second board, the auxiliary substrate being aligned with the substrate for performing the exposure polymerization manufacturing process so as to combine the auxiliary substrate and the substrate, and accomplishing the separation of the charged pigment particle solution from the polymerization material so as to make the charged pigment particle solution confined by the polymer, and stripping out the auxiliary substrate so as to form a single substrate electrophoretic display.

2. The manufacturing method for an electrophoretic display of claim 1, wherein the optical polymer material is photocurable resin.

3. The manufacturing method for an electrophoretic display of claim 1, wherein the auxiliary substrate or the substrate is a substrate made of material of glass, chip, Teflon or plastics.

4. The manufacturing method for an electrophoretic display of claim 3, wherein on the auxiliary substrate or the substrate, an light absorption or light reflection layer manufacturing process is performed for displaying.

5. The manufacturing method for an electrophoretic display of claim 1, wherein the electrode patterns are made of the material of electric conduction film.

6. The manufacturing method for an electrophoretic display of claim 5, wherein the electric conduction film is indium-tin oxide (ITO) or polyethylene-dioxithiophene (PEDOT).

7. The manufacturing method for an electrophoretic display of claim 1, wherein the buffer layer is made of material of polyethylene hydrophobic material (PE/PEWax), long chain fatty acids, Silicone, Teflon.

8. The manufacturing method for an electrophoretic display of claim 1, wherein in the step of the manufacturing process for the first board, a step for manufacturing the electrode patterns on the auxiliary substrate is further comprised.

9. The manufacturing method for an electrophoretic display of claim 1, wherein in the manufacturing process for the second board, an optical mask exposure polymerization manufacturing process or a molding method can be used for making the polymerization material form the polymer walls.

10. The manufacturing method for an electrophoretic display of claim 9, wherein the molding method can be operated with one of a heating process and an irradiating ultraviolet rays so as to solidify and polymerize the optical polymer material.

11. The manufacturing method for an electrophoretic display of claim 1, wherein the polymer wall formed by the optical polymer material is a closed matrix polymer wall.

12. The manufacturing method for an electrophoretic display of claim 1, wherein the polymer wall formed by the optical polymer material is a non-closed matrix polymer wall.

13. The manufacturing method for an electrophoretic display of claim 1, wherein the optical polymer material mixture is composed of the optical polymer material and the charged pigment particle solution.

14. The manufacturing method for an electrophoretic display of claim 13, wherein intervals are further added in the optical polymer material mixture.

15. A manufacturing method for an electrophoretic display comprising:
performing a manufacturing process for a first board to coat the optical polymer material on an auxiliary substrate having a buffer layer and solidify the material by exposing ultraviolet rays, and for manufacturing electrode patterns on the exposed and solidified optical polymer material layer;
performing a manufacturing process for a second board, after the optical polymer material coated on a substrate, the optical polymer material being solidified by exposing ultraviolet rays, electrode patterns being manufactured on the exposed and solidified optical polymer material layer, and then optical polymer material being coated on the layer again, an optical mask exposure being used for solidifying the polymerization material so as to form polymer walls, in holes surrounded by the polymer walls, a mixture composed of charged pigment particles and a few amount of optical polymer material being filled so as to accomplish the manufacturing of the second board;
performing the manufacturing process for combining the first board and the second board, the auxiliary substrate being aligned with the substrate for performing the exposure polymerization manufacturing process so as to combine the auxiliary substrate and the substrate, and accomplishing the separation of the charged pigment particle solution from the polymerization material so as to make the charged pigment particle solution confined by the polymer, and stripping the auxiliary substrate from the substrate so as to form an electrophoretic display without substrate.

16. The manufacturing method for an electrophoretic display of claim 15, wherein the optical polymer material is photo-curable resin.

17. The manufacturing method for an electrophoretic display of claim 15, wherein the auxiliary substrate or the substrate is a substrate made of material of glass, chip, Teflon or plastics.

18. The manufacturing method for an electrophoretic display of claim 17, wherein on the auxiliary substrate or the substrate, an light absorption or light reflection layer manufacturing process is performed for displaying.

19. The manufacturing method for an electrophoretic display of claim 15, wherein the electrode patterns are made of the material of electric conduction film.

20. The manufacturing method for an electrophoretic display of claim 19, wherein the electric conduction film is indium-tin oxide (ITO) or polyethylene-dioxithiophene (PEDOT).

21. The manufacturing method for an electrophoretic display of claim 15, wherein the buffer layer is made of material of polyethylene hydrophobic material (PE/PEWax), long chain fatty acids, Silicone, Teflon.

22. The manufacturing method for an electrophoretic display of claim 15, wherein in the step of the manufacturing process for the first board, a step for manufacturing the electrode patterns on the auxiliary substrate is further comprised.

23. The manufacturing method for an electrophoretic display of claim 15, wherein in the manufacturing process for the second board, an optical mask exposure polymerization manufacturing process or a molding method can be used for making the polymerization material form the polymer walls.

24. The manufacturing method for an electrophoretic display of claim 23, wherein the molding method can be operated with one of a heating process and an irradiating ultraviolet rays so as to solidify and polymerize the optical polymer material.

25. The manufacturing method for an electrophoretic display of claim 15, wherein the polymer wall formed by the optical polymer material is a closed matrix polymer wall.

26. The manufacturing method for an electrophoretic display of claim 15, wherein the polymer wall formed by the optical polymer material is a non-closed matrix polymer wall.

27. The manufacturing method for an electrophoretic display of claim 15, wherein the optical polymer material mixture is composed of the optical polymer material and the charged pigment particle solution.

28. The manufacturing method for an electrophoretic display of claim 27, wherein intervals are further added in the optical polymer material mixture.
